(19) United States
(12) Patent Application Publication
(10) Pub. No.: US 2004/0200918 A1
(43) Pub. Date: Oct. 14, 2004

(54) Cartridge transfer manipulator

(75) Inventor: David Michael Davis, Tucson, AZ (US)

Correspondence Address: SCULLY SCOTT MURPHY & PRESSER, PC, 400 GARDEN CITY PLAZA, GARDEN CITY, NY, 11530

(73) Assignee: International Business Machines Corporation, Armonk, NY

(21) Appl. No.: 10/413,346

(22) Filed: Apr. 14, 2003

(51) Int. Cl. G11B 23/04

(52) U.S. Cl. 242/338.4

(57) ABSTRACT

A cartridge loading and unloading mechanism, and in particular, pertains to a removable media cartridge transfer manipulator for accurately positioning a cartridge into a deck tape or other removable media for the purpose of data interchange. Also provided is a method for implementing the manipulation of the cartridge.

### BACKGROUND OF THE INVENTION

1. Field of the Invention

The present invention relates to a cartridge loading and unloading mechanism, and in particular, pertains to a removable media cartridge transfer manipulator for accurately positioning a cartridge into a deck tape or other removable media for the purpose of data interchange.

Basically, referring to tape drives, tape cartridges are loaded into tape decks so as to engage or contact capstans to facilitate data transfer, such as in automated data storage libraries, as is well known in the technology. In order to assist in implementation of the correct or accurate positioning of the magnetic tape cartridge within the confines of the tape deck during insertion thereinto the sides of the magnetic tape may be provided with suitable structure which will assist in retaining of the magnetic tape in position in the tape deck. However, currently the accuracy which is attained during the loading of the magnetic tapes into the tape decks has not achieved the desired degree of accuracy, and any inadvertent movement encountered during the loading of the magnetic tapes into tape decks heretofore resulted, at times, in misregistrations which cause negative effects on the cartridge loading sequence and the utilization of the cartridge. Hereby, the cartridge has to be pinched or snapped into place so as to refrain from inadvertent movement during loading cycles into the cartridge tape deck. Moreover, presently employed cartridge loading mechanisms or manipulators are also frequently large sized and complex structures required for the loading of the magnetic tape cartridges into the tape decks, thereby considerably increasing costs and maintenance expenditures for the tape decks.

Heretofore, various tape decks and their operative constructions which receive the magnetic tape cartridges have been employed in engaging the cartridges in their storage cells in automated data storage libraries. To that effect, the conveying of the cartridges into the tape decks drive has been to clamp on the cartridge vertically, for instance, from the bottom thereof, which tends to “essentially grab” the cartridge in order to start the loading cycle during cartridge insertion into the drive arrangement of the tape deck. Basically, this type of cartridge grabbing tends to hold the cartridge reasonably close in its relative desired position as it is translated within the tape deck during the loading cycle, whereas proximate the end of the cartridge loading cycle, tapered alignment pins normally finish cartridge alignment into accurate positioning thereof.

In addition to engaging the sides of the magnetic tape cartridges to assist loading the latter into tape decks, in essence into their drives, features have been employed for biasing the bottom of the cartridge upwardly in conjunction with engaging the magnetic tape cartridge along the sides thereof. However, these particular cartridge loading structures are generally complex in nature and do not readily achieve the fine degree of adjustment or accuracy which is desired during tape cartridge loading into the tape decks.

2. Discussion of the Prior Art

Vogel, U.S. Pat. No. 3,957,225 discloses a cartridge latching mechanism wherein the mechanism employed for the insertion or loading of a magnetic tape cartridge into a tape deck or housing structure containing drive elements for the tape cartridge and magnetic heads for reading and writing the tape includes a rotatable or spring-biased component which not only cooperates with any side guidance of the cartridge but also provides an upwardly directed biasing force. This is accomplished through the intermediary of engaging a slot in the cartridge so as to drive the cartridge forcibly into position. In that connection, the resultant pinching or grabbing action imparts a strenuous load to the tape cartridge and does not always impart the necessary positioning accuracy, while the mechanism is constituted of relatively complicated rotatable and spring-biased operating structure and movable parts.

Leifer, et al., U.S. Pat. No. 3,977,624 discloses a locking and drive mechanism for positioning magnetic tape cartridges into accurate alignment with a stationary capstan drive, wherein, rotatable or pivotal arm structure grabbingly engages the cartridge from the bottom thereof so as to assist in aligning the cartridge in conjunction with side guides while being loaded into a tape deck. Again, this is a relatively complicated structure requiring extensive space for the operative mechanism in the tape deck, while concurrently increasing the cost thereof, and complexities in the functioning of the device.

Kramer, et al., U.S. Pat. No. 4,303,955 discloses an apparatus for securing in and releasing tape cartridges from tape decks, wherein in addition to guidance aspects which are implemented along the sides of a magnetic tape cartridge while being inserted into the tape deck, a generally curved upwardly extending leaf spring engages the bottom surface of the cartridge to thereby bias the latter upwardly during its forward motion within the tape deck into contact with a stationary capstan. This particular type of construction does not in itself provide the desired accuracy in the loading of the magnetic tape cartridge into the upright position or precise positioning thereof within the tape deck in a manner avoiding pinching or grabbing of the tape.

Finally, Japanese Patent No. JP 62267961 discloses a mechanism for engaging and loading cassettes or cartridges into a tape deck through the action of spring-biased engagement releasing members. The engaging part of the member is made to cooperate with a positioning aperture in the cassette and through a grabbing motion pulls the cassette into position. This mechanism entails the use of a considerable number of bulky, complicated and space-consuming components of the type which are intended to be eliminated by the inventive cartridge manipulating and transfer mechanism.

### SUMMARY OF THE INVENTION

In order to avoid the foregoing disadvantages to which the prior art is subject, both as to structure and functioning, pursuant to the present invention there is eliminated the “grabbing” or pinching of the cartridge in order to start the loading cycle for insertion into the drive arrangement of the deck, in that the disclosure is directed to the provision of a pair of features in the deck, which are pivoted above the cartridge floor and in the front region of the media cartridge upon initial insertion thereof into the deck and which are traversed into meshing engagement with the side of the cartridge. This provides a relatively simple and advantageous compact construction which avoids positioning movable and complex grabbing or biasing components beneath the media cartridge, restrains the cartridge from inadvertent movement or displacement during insertion or loading into the deck and, concurrently, in operative conjunction with the side structure of the cartridge, draws the cartridge into fine alignment during the loading cycle and precise placement onto tapered pins which are normally provided in deck. In effect, the pivoting of guiding structure or manipulator above the cartridge floor or bottom surface requires less energy in order to provide meshing engagement with the structure or drive of the deck, and mechanical locking free from any inadvertent cartridge retraction caused by the cartridge loader or manipulator mechanism until parked at the final position in the tape deck.

Although alignment features have been heretofore available in the side of cartridges, these features have most notably been used to retain the cartridges into their storage “cells” in automated libraries. The cartridge retention for engagement into the drive has been to clamp on it vertically, as this would “grab” the cartridge to start the load cycle upon cartridge insertion into the deck drive. This cartridge grabbing would hold the cartridge reasonably close to relative position as it translated the load cycle; while upon approach to the end of the load cycle, tapered alignment pins would finish the cartridge alignment.

Pursuant to the invention, the aspect of cartridge grabbing is eliminated, and in lieu thereof, upon cartridge insertion a pair of features lift from the floor of the cartridge loader at the start of load. These features, which are essentially pivoted above the cartridge floor and in the front region of the deck structure, traverse into mesh or engaging contact with the side of the cartridge. These features, being tapered, immediately trap or restrain the cartridge from inadvertent movement, and pull the cartridge into fine alignment during the load cycle for placement onto final alignment pins. Pivoting above the cartridge floor facilitates a) less energy being required to provide meshing engagement, and b) mechanical geometric locking against any inadvertent retraction of the cartridge encountered from the cartridge loader mechanism, until parked at unload position.

Accordingly, it is an object of the present invention to provide a novel and simply operated cartridge transfer manipulator in a deck for implementing the accurate loading and unloading of a magnetic tape or media cartridge.

Another object of the invention is to provide a novel structure for manipulating a media cartridge during loading into a deck, which cooperates with features at the front zone and side of the cartridge so as to guide the latter accurately into engagement with final alignment pins and a capstan for the transfer of data in an automated data storage library.

### BRIEF DESCRIPTION OF THE ACCOMPANYING DRAWINGS

Reference may now be made to the following detailed description of a preferred embodiment of the invention, taken in conjunction with the accompanying drawings showing essential features of the media cartridge transfer manipulator; in which:

FIGS. 1A and 1B each, respectively, illustrate perspective side and bottom views of the inventive cartridge transfer manipulator with a cartridge shown in the outwardly extended position at initiation of insertion into a deck; and with the side plate of the manipulator shown as having been removed in FIG. 1B for purpose of clarity in viewing the operative manipulator mechanism;

FIGS. 2A and 2B are each similar to FIGS. 1A and 1B, while showing the media cartridge in a partially inserted loading position in the deck;

FIGS. 3A and 3B are each similar to FIGS. 1A and 1B the illustrating media cartridge in a somewhat further inserted loading position in the deck;

FIGS. 4A and 4B are each similar to FIGS. 1A and 1B and illustrating the media cartridge in a fully inserted or loaded position in the deck; and

FIG. 5 illustrates a further view of the cartridge in a fully inserted position, shown with the manipulator arrangement in contact therewith.

### DETAILED DESCRIPTION OF A PREFERRED EMBODIMENT

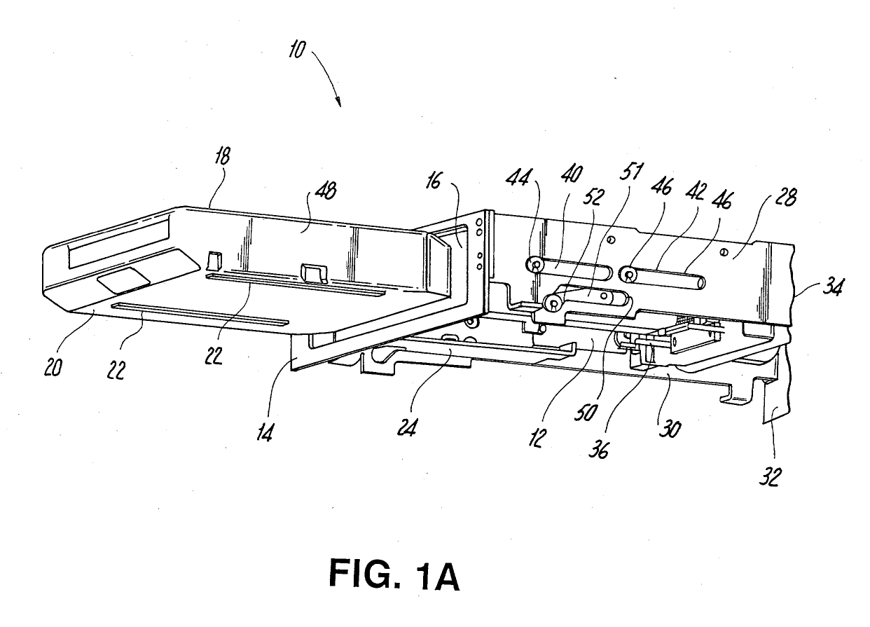

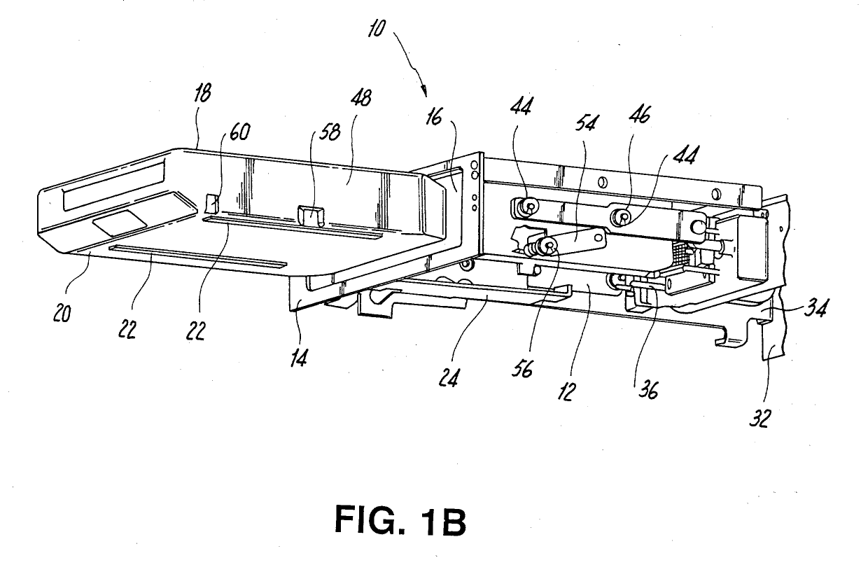

Referring to FIGS. 1A and 1 B of the drawings, there is illustrated a section of a deck 10 including a cartridge transfer manipulator arrangement 12. In particular, the construction thereof, as illustrated, in FIG. 1A, comprises a front plate 14 having an insert aperture 16 for the loading of a cartridge 18, the bottom surface 20 of which has two parallel spaced strip members 22 adapted to contactingly engage in guided relation with cooperating plates 24 extending along the lower edge portion 22 of the deck manipulator arrangement 12. The cooperating plates 24 extend inwardly towards each other from parallel sidewalls 28,30 which are fastened to front plate 14, and which connect to a back plate 32 at their opposite, rearward ends 34. Arranged intermediate the sidewalls 28,30 in proximity to back plate 32 are tapered alignment pins 36, a capstan (not shown) and the various operative components of the deck, as is well known in the technology, which may pertain to data transfer and/or recording, and automated data storage libraries, of which the deck may comprise a constituent.

As indicated in FIG. 1A, a slot arrangement consisting of first and second slots 40,42 formed coaxially in sidewalls 28,30 each houses alignment roller-type contact elements 44,46 comprising rollers 44 connected to bar 46, which are adapted to slidingly engage the opposite sides 48 of the cartridge 18 as the latter is being inserted into the deck 10. Located therebelow, pursuant to the invention as also clearly shown in the drawing is a further slot 50 in each sidewall 28,30 with a rearward horizontal slot portion 51 and a forward downwardly angled slot portion 52, having a pivotable lever 54 inserted therein, including a roller member 56 having an inner facing plate element 57 extending within the slot which is adapted to face the side 48 and contact protuberant features 58,60 provided on each side of the cartridge 18 for accurately guiding the latter during loading into engagement with final end pins and media interface in the deck 10.

As illustrated in FIG. 1B, wherein the sidewall 28 of deck 10 has been omitted for purpose of clarity, the upper lever structure has roller members 44 spaced for causing bar 46 contacting the opposite sides 48 of the media cartridge 18 as the latter is being inserted and advanced into the deck 10 through the insert aperture 16, and with the bottom strip member 22 slidingly engaging the inward facing edges of the lower plates 24 of the deck, so as to facilitate accurate guidance of the magnetic tape cartridge 18 towards its final fully inserted position within the deck 10.

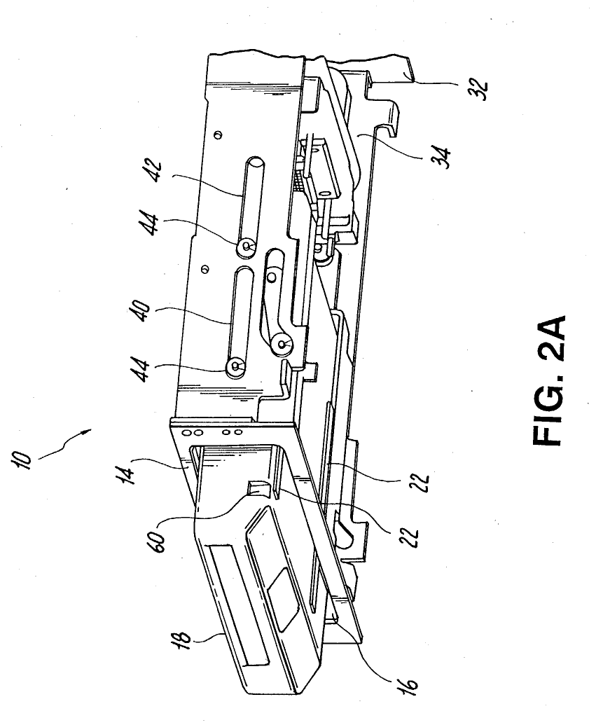

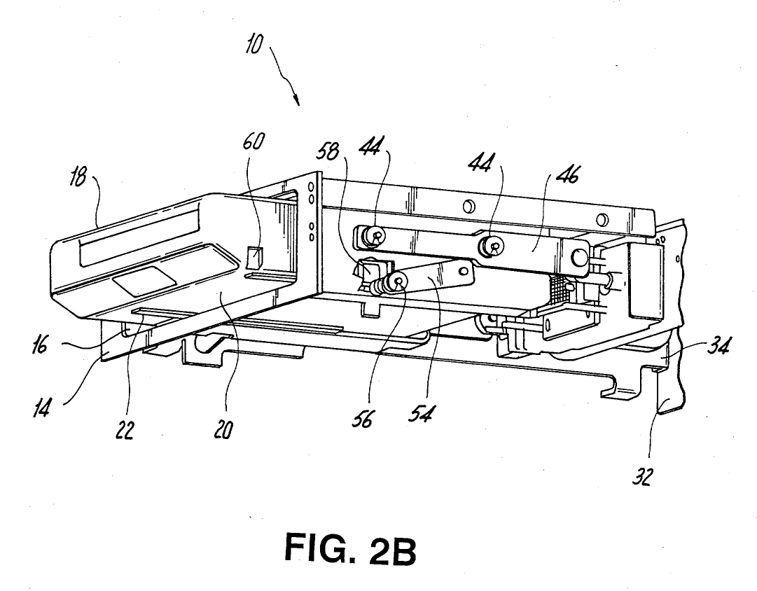

In the instance, as illustrated in FIGS. 2A and 2B, wherein the cartridge 18 is in a partially inserted position in the deck 10, the pivot lever 54 swings upwardly as the roller member 56 is caused to travel from angled slot portion 52 into the rearward slot portion 51, with the contact elements 44, 46 concurrently engaging the cartridge 18 on opposite sides 48 thereof.

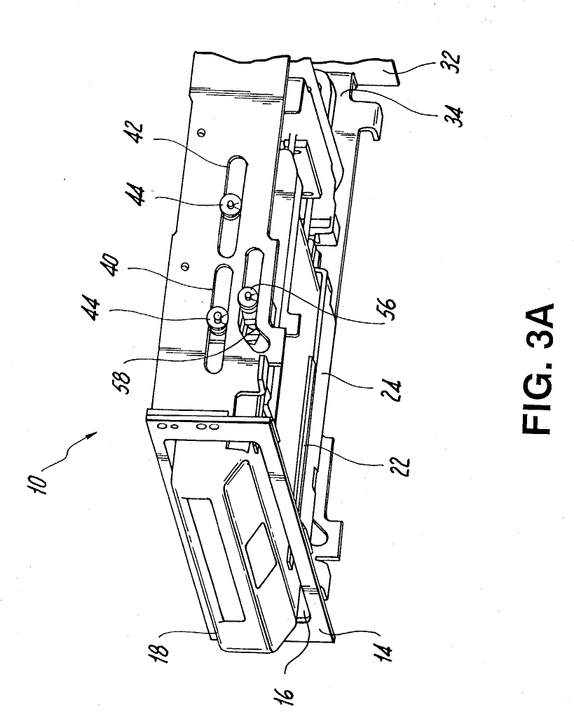

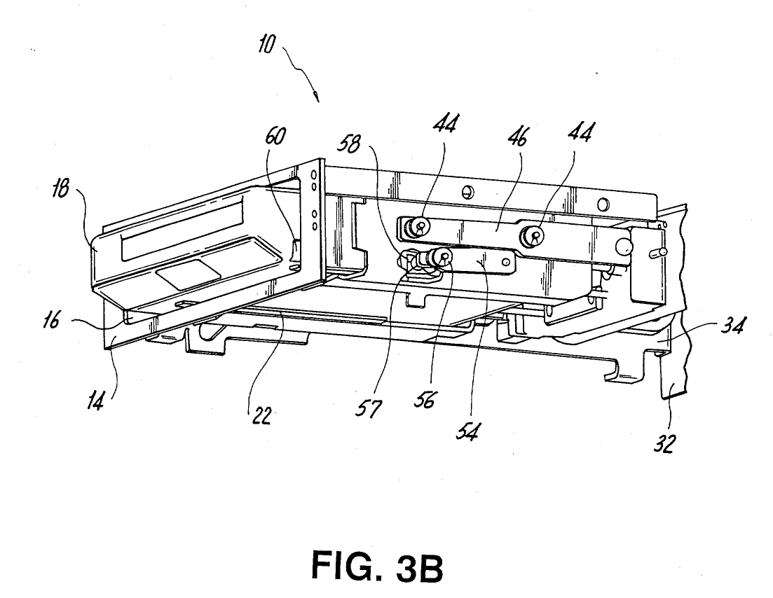

As the cartridge 18 is advanced, as shown in FIGS. 3A and 3B, the inwardly extending roller or runner member 56 has plate 57 designed to engage protruding bosses or features 58, 60 located to project outwardly on the side 48 of the cartridge 18, on opposite sides thereof, so as to assist in accurately guiding the cartridge upwardly in conjunction with the above-mentioned guides 44, 46 which also align the cartridge within the deck. This is clearly illustrated in FIGS. 3A and 3B of the drawings, as the cartridge 18 approaches the final loaded position in the deck 18.

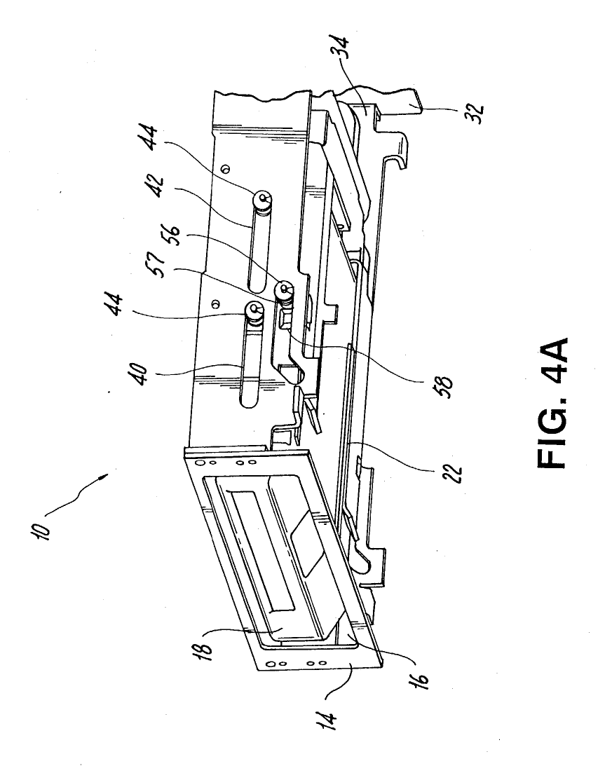

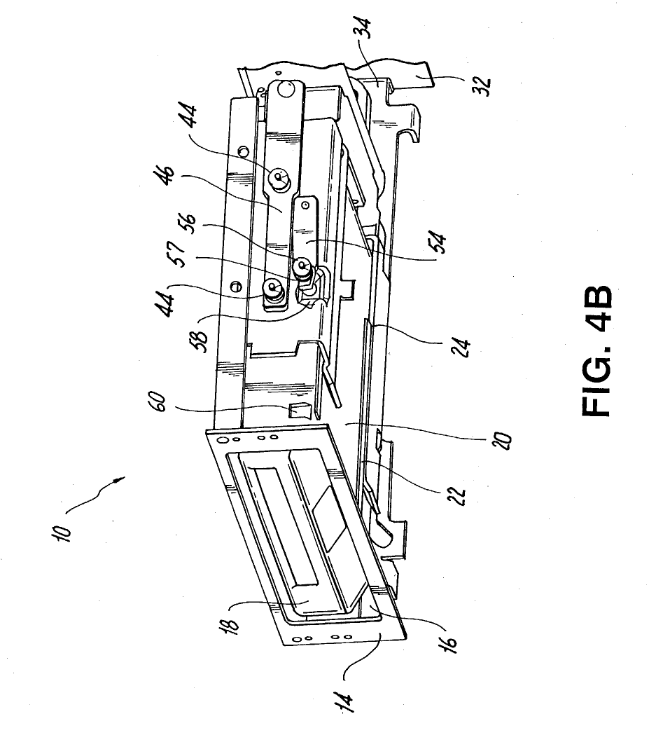

As illustrated in FIGS. 4A and 4B showing the cartridge 18 in its fully loaded or inserted position in the deck 10, the lower pivot lever 54 is in an upward pivoted position where the inwardly extending roller element 56 contacts a tapered boss formed on each side 48 of the cartridge, constituting features 58,60, which will accurately align the cartridge 18 in the loaded position thereof within the deck 10.

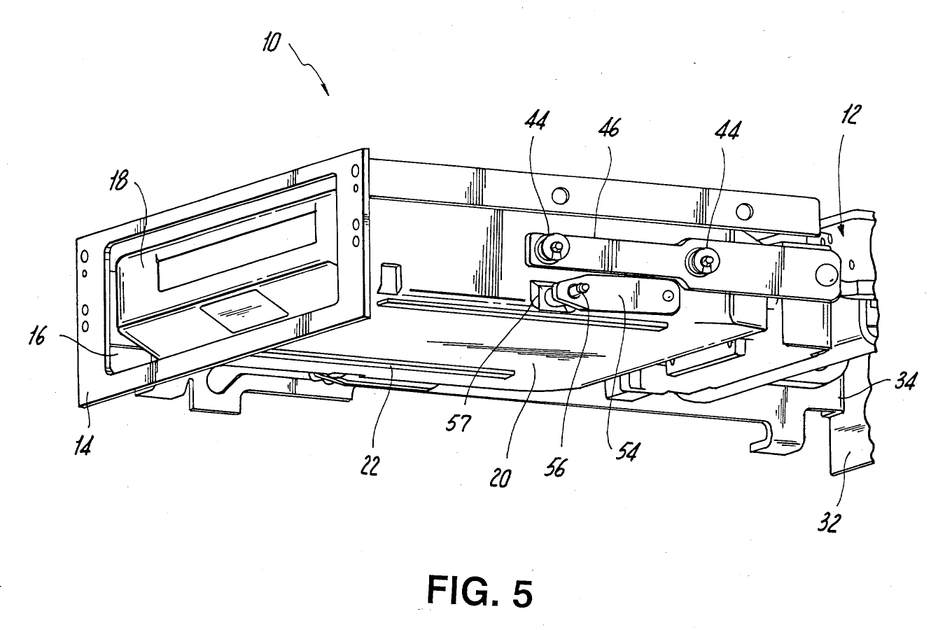

Furthermore, as shown in FIG. 5 of the drawings, wherein the outer facing sidewalls of the deck transfer manipulator have been removed for purposes of clarity, there is shown the upper guide bar having the contact members 44, 46 contacting the side 48 of the fully inserted cartridge 18, and with the pivotable lower lever 54 being upwardly pivoted such that the inwardly extending roller or runner 56 contacts the feature or boss 58,60 provided on the side 48 of the cartridge, with the lower plate portions of the tape deck transfer manipulator 12 shown as having been removed for purposes of clarity.

From the foregoing, it becomes readily apparent to one of skill in the art that the present invention provides for a simple structure in guiding the media cartridge 18 by means of the novel cartridge transfer manipulator arrangement 12 so as to assist in the accurate loading into and unloading from the deck 10 and its guidance into the drive of the deck in a compact and highly accurate manner.

Basically, the invention is applicable to any cartridge containing removable media. Such cartridges may include diverse types of removable media, including but not limited to magnetic tape, magnetic disk drive, and optical media, such as high-speed removable media technology.

While the invention has been particularly shown and described with respect to a preferred embodiment thereof, it will be understood by those skilled in the art that the foregoing and other changes in form and details may be made therein without departing from the spirit and scope of the invention.

What is claimed is:

1. A cartridge transfer manipulator mechanism for loading a cartridge into and unloading from a cartridge deck, said cartridge having guide features formed on opposite sides thereof; comprising:
said deck including a housing having a front aperture for the inserting therethrough of said media cartridge, said housing having sidewalls extending in close proximity to said opposite sides of the tape cartridge during insertion of said cartridge, a plurality of slots being formed in each of said housing sidewalls, and guide structure in said housing slidingly communicating with said slots for contacting said cartridge sides and/or engaging said guide features formed on the opposite sides of said cartridge so as to facilitate the accurate manipulation thereof during loading into and unloading from said deck.

2. A manipulator mechanism as claimed in claim 1, wherein said plurality of slots comprise first and second elongate slots in coaxial spaced relationship formed in said housing sidewalls, said guide structure comprising rollers displaceable within each of said slots; a bar member connected to said rollers interiorly of said slots so as to be in slidable guiding contact with the adjacent side of the media cartridge during insertion thereof into said deck housing.

3. A manipulator mechanism as claimed in claim 2, wherein a third slot is formed in each sidewall of said housing extending below said first and second elongate slots; and roller means connected to a pivotable lever extending into said third slot, said roller means including an element connected to an inner end for engaging said guide features on the sides of said cartridge to assist in the guidance thereof during loading into and unloading from said deck.

4. A manipulator mechanism as claimed in claim 3, wherein said roller means is fastened to a swingably movable end of a pivotable lever having a rotatable distal end fixedly connected to said deck housing.

5. A manipulator mechanism as claimed in claim 4, wherein said third slot comprises a first slot portion extending in parallel spaced relationship with said first and second elongate slots, and a second slot portion extending angled downwardly and forwardly towards the front end of said housing from said first slot portion, said roller means being displaced upwardly from said second slot portion into said first slot portion during insertion of said media cartridge so as to cause said element connected thereto to engage the guide features on said cartridge.

6. A manipulator mechanism as claimed in claim 2, wherein said guide features on the sides of said media cartridge comprise raised structures formed in said sides.

7. A manipulator mechanism as claimed in claim 6, wherein said raised structures comprise bosses having surfaces engageable by surfaces of the elements at the inner ends of each of said roller means.

8. A manipulator mechanism as claimed in claim 1, wherein said media cartridge comprises a cartridge containing removable media, including magnetic tape, magnetic disk drive and optical media.

9. A method for loading a media cartridge into and unloading from a cartridge deck, said tape cartridge having guide features formed on opposite sides thereof; comprising:
inserting said cartridge into a housing of said tape deck having a front aperture for the inserting therethrough of said cartridge, said housing having sidewalls extending in close proximity to said opposite sides of the cartridge during insertion of said deck, a plurality of slots being formed in each of said housing sidewalls, and guide structure in said housing slidingly communicating with said slots for contacting said cartridge sides and/or engaging said guide features formed on the opposite sides of said cartridge so as to facilitate the accurate manipulation thereof during loading into and unloading from said deck.

10. A method as claimed in claim 9, wherein said plurality of slots comprise first and second elongate slots in coaxial spaced relationship formed in said housing sidewalls, said guide structure comprising rollers displaceable within each of said slots; a bar member connected to said rollers interiorly of said slots so as to be in slidable guiding contact with the adjacent side of the media cartridge during insertion thereof into said deck housing.

11. A method as claimed in claim 10, wherein a third slot is formed in each sidewall of said housing extending below said first and second elongate slots; and roller means connected to a pivotable lever extending into said third slot, said roller means including an element connected to an inner end for engaging said guide features on the sides of said media cartridge to assist in the guidance thereof during loading into and unloading from said deck.

12. A method as claimed in claim 11, wherein said roller means is fastened to a swingably movable end of a pivotable lever having a rotatable distal end fixedly connected to said deck housing.

13. A method as claimed in claim 12, wherein said third slot comprises a first slot portion extending in parallel spaced relationship with said first and second elongate slots, and a second slot portion extending angled downwardly and forwardly towards the front end of said housing from said first slot portion, said roller means being displaced upwardly from said second slot portion into said first slot portion during insertion of said media cartridge so as to cause said element connected thereto to engage the guide features on said cartridge.

14. A method as claimed in claim 10, wherein said guide features on the sides of said media cartridge comprise raised structures formed in said sides.

15. A method as claimed in claim 14, wherein said raised structures comprise bosses having surfaces engageable by surfaces of the elements at the inner ends of each of said roller means.

16. A method as claimed in claim 9, wherein said media cartridge comprises a cartridge containing removable media, including magnetic tape, magnetic disk drive and optical media.
